(19) United States
(12) Patent Application Publication
(10) Pub. No.: US 2023/0162147 A1
(43) Pub. Date: May 25, 2023

(54) INVENTORY POSSESION SYSTEM AND METHOD

(71) Applicants: Milton Edward Ives, Bolton, CT (US); Joseph Rampone, Berlin, CT (US)

(72) Inventors: Milton Edward Ives, Bolton, CT (US); Joseph Rampone, Berlin, CT (US)

(21) Appl. No.: 18/054,904

(22) Filed: Nov. 13, 2022

Related U.S. Application Data
(60) Provisional application No. 63/264,296, filed on Nov. 19, 2021.

(51) Int. Cl. G06Q 10/08

(52) U.S. Cl. CPC G06Q 10/087

(57) ABSTRACT

In some aspects, an apparatus may include one or more processors configured to identify at least one of a holding company, a manufacturing company and a customer; identify the steps of an inventory management cycle including any of a raw material procurement, a raw material inventory, a work in process inventory, a finished goods inventory, a shipping inventory and accounts payable and provide an inventory possession model configured to allocate ownership of the raw material procurement, the raw material inventory, the work in process inventory, the finished goods inventory, the shipping inventory and the accounts payable amongst any of the holding company, a manufacturing company and a customer and allocate physical possession of the raw material procurement, the raw material inventory, the work in process inventory, the finished goods inventory, the shipping inventory and the accounts payable amongst any of the holding company, a manufacturing company and a customer.

### Cross Reference To Related Applications

This application claims the benefit of United States Provisional Patent Application Serial No. 63/264,296 having a filing date of 19 Nov. 2021. The disclosure of the application above is incorporated herein by reference in its entirety.

### BACKGROUND OF THE INVENTION

### Field of the Invention

The present disclosure relates to inventory possession systems and methods.

### Description of the Related Art

The cost and management of inventory is one of the largest issues that manufacturers undertake. Inventory costs impact the profitability of manufacturing companies as much as any other metric, as well as the fact that inventory ties up capital that could be used elsewhere for organic and acquisition growth, capital investment, and myriad other purposes. Such impacts of inventory ownership and management are also known in retail, financial, accounting and other industries.

Referring to FIG.1, there is shown a typical inventory ownership process flow 10 of the prior art for Company B preparing goods for Customer A. In this particular example. Company B pays for, and owns, the inventory from the purchase of raw material to the raw material sitting in inventory, through work in process (WIP) to finished goods and shipping to Customer A. Company B then carries the cost while the payment terms are completed.

Referring to FIG. 2, there is shown existing consignment or inventory holding model and ownership process flow 20 of the prior art. In this particular embodiment, Company B can be a manufacturing company preparing goods for Customer A. Company C enters into a contractual arrangement with Company B and purchases raw material at step 21. Company C owns and physically holds the raw material inventory until a predetermined date when Company B takes possession of the raw material at step 22. Company B then owns and possesses the inventory from inventory of raw material at step 22 (although it may be momentarily as during a just-in-time manufacturing scenario), WIP at step 23, to finished goods at step 24 and shipping to Customer A and shipping at step 25. Customer A buys finished goods at step 26, takes physical possession, pays Company B in accordance with their terms and the finished goods can go into Customer A inventory. It should be appreciated by those skilled in the art that WIP includes all work in process including a standard work product flow, a material review board work (MRB), a non-conforming work and a non-standard product flow.

Many manufacturers turn to banks and traditional lenders to provide loans that are backed by the inventory as it winds its way from raw material to WIP to finished product. These loans are typically referred to as asset backed loans Such prior art systems covering inventory asset back loans are disclosed in US20110016042, the contents of which are incorporated herein in their entirety. As will be disclosed in more detail herein below, such asset backed loans lack flexibility and advantages sought by manufacturers.

The examples of the prior art lack the ability to provide manufacturers the flexibility to capitalize their inventory at various points along the manufacturing process or to take ownership of the inventory at a point when it is financial advantageous to do so.

### SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, an inventory possession method may include identifying at least one of a holding company, a manufacturing company and a customer. The inventory possession method may also include identifying the steps of an inventory management cycle including any of a raw material procurement, a raw material inventory, a work in process inventory, a finished goods inventory, a shipping inventory and an accounts payable. The method may furthermore include providing an inventory possession model having allocating ownership of the raw material procurement, the raw material inventory, the work in process inventory, the finished goods inventory, the shipping inventory and the accounts payable amongst any of the holding company, a manufacturing company and a customer, and allocating physical possession of the raw material procurement, the raw material inventory, the work in process inventory, the finished goods inventory, the shipping inventory and the accounts payable amongst any of the holding company, a manufacturing company and a customer. Other embodiments of this aspect include corresponding computer systems, apparatus, and computer programs recorded on one or more computer storage devices, each configured to perform the actions of the methods.

Implementations may include one or more of the following features. The inventory possession method where the allocating is performed at any of a date certain, an event certain, a trigger point or upon demand. The inventory possession method having allocating the ownership of the raw material procurement to the holding company, allocating physical possession of the raw material inventory, the work in process inventory, the finished goods inventory, the shipping inventory to the manufacturing company, transferring the ownership of the raw material inventory from the holding company to the manufacturing company, transferring the physical possession of the shipping inventory from the manufacturing company to the customer, and transferring the ownership of the shipping inventory from the manufacturing company to the customer. The inventory possession method having allocating the ownership of the raw material procurement and the raw material inventory to the holding company, allocating physical possession of the raw material inventory, the work in process inventory, the finished goods inventory and the shipping inventory to the manufacturing company, transferring the ownership of the raw material inventory from the holding company to the manufacturing company, transferring the physical possession of the shipping inventory from the manufacturing company to the customer, and transferring the ownership of the shipping inventory from the manufacturing company to the customer. The inventory possession method having allocating the ownership of the raw material procurement, the raw material inventory and the work in process inventory to the holding company, allocating physical possession of the raw material inventory, the work in process inventory, the finished goods inventory and the shipping inventory to the manufacturing company, transferring the ownership of the raw material inventory and the work in process inventory from the holding company to the manufacturing company, transferring the physical possession of the shipping inventory from the manufacturing company to the customer, and transferring the ownership of the shipping inventory from the manufacturing company to the customer. The inventory possession method having allocating the ownership of the raw material procurement, the raw material inventory, the work in process inventory and the finished goods inventory to the holding company, allocating physical possession of the raw material inventory, the work in process inventory, the finished goods inventory and the shipping inventory to the manufacturing company, transferring the ownership of the raw material inventory, the work in process inventory and the finished goods inventory from the holding company to the manufacturing company, transferring the physical possession of the shipping inventory from the manufacturing company to the customer, and transferring the ownership of the shipping inventory from the manufacturing company to the customer. The inventory possession method having allocating the ownership of the raw material procurement, the raw material inventory, the work in process inventory, the finished goods inventory and the shipping inventory to the holding company, allocating physical possession of the raw material inventory, the work in process inventory, the finished goods inventory and the shipping inventory to the manufacturing company, transferring the physical possession of the shipping inventory from the manufacturing company to the customer, and transferring the ownership of the raw material inventory, the work in process inventory, the finished goods inventory and the shipping inventory from the holding company to the customer. Implementations of the described techniques may include hardware, a method or process, or a computer tangible medium.

In one general aspect, an inventory possession system may include a microprocessor configured to . Inventory possession system may also include identify at least one of each of a holding company, a manufacturing company and a customer. The system may furthermore include identify the steps of an inventory management cycle including any of a raw material procurement, a material inventory, a work in process inventory, a finished goods inventory, a shipping inventory and an accounts payable. The system may in addition include allocate ownership of the raw material procurement, the material inventory, the work in process inventory, the finished goods inventory, the shipping inventory and the accounts payable amongst each of the holding company, a manufacturing company and a customer in accordance with an inventory possession model. The system may moreover include allocate physical possession of the raw material procurement, the material inventory, the work in process inventory, the finished goods inventory, the shipping inventory and the accounts payable amongst each of the holding company, a manufacturing company and a customer in accordance with the inventory possession model. The system may also include where the allocating is performed at any of a date certain, a trigger point or upon demand. Other embodiments of this aspect include corresponding computer systems, apparatus, and computer programs recorded on one or more computer storage devices, each configured to perform the actions of the methods.

In one general aspect, a system may include one or more processors configured to identify at least one of a holding company, a manufacturing company and a customer, identify the steps of an inventory management cycle including any of a raw material procurement, a raw material inventory, a work in process inventory, a finished goods inventory, a shipping inventory and an accounts payable, and provide an inventory possession model configured to allocate ownership of the raw material procurement, the raw material inventory, the work in process inventory, the finished goods inventory, the shipping inventory and the accounts payable amongst any of the holding company, a manufacturing company and a customer, and allocate physical possession of the raw material procurement, the raw material inventory, the work in process inventory, the finished goods inventory, the shipping inventory and the accounts payable amongst any of the holding company, a manufacturing company and a customer. Other embodiments of this aspect include corresponding computer systems, apparatus, and computer programs recorded on one or more computer storage devices, each configured to perform the actions of the methods.

Implementations may include one or more of the following features. The system where the inventory possession model is further configured to allocate the ownership and allocate physical possession at any of a date certain, an event certain, a trigger point or upon demand. The system where the inventory possession model is configured to allocate the ownership of the raw material procurement to the holding company, allocate physical possession of the raw material inventory, the work in process inventory, the finished goods inventory, the shipping inventory to the manufacturing company, transfer the ownership of the raw material inventory from the holding company to the manufacturing company, transfer the physical possession of the shipping inventory from the manufacturing company to the customer, and transfer the ownership of the shipping inventory from the manufacturing company to the customer. The system where the inventory possession model is configured to allocate the ownership of the raw material procurement and the raw material inventory to the holding company, allocate physical possession of the raw material inventory, the work in process inventory, the finished goods inventory and the shipping inventory to the manufacturing company, transfer the ownership of the raw material inventory from the holding company to the manufacturing company, transfer the physical possession of the shipping inventory from the manufacturing company to the customer, and transfer the ownership of the shipping inventory from the manufacturing company to the customer. The system where the inventory possession model is configured to allocate the ownership of the raw material procurement, the raw material inventory and the work in process inventory to the holding company, allocate physical possession of the raw material inventory, the work in process inventory, the finished goods inventory and the shipping inventory to the manufacturing company, transfer the ownership of the raw material inventory and the work in process inventory from the holding company to the manufacturing company, transfer the physical possession of the shipping inventory from the manufacturing company to the customer, and transfer the ownership of the shipping inventory from the manufacturing company to the customer. The system where the inventory possession model is configured to allocate the ownership of the raw material procurement, the raw material inventory, the work in process inventory and the finished goods inventory to the holding company, allocate physical possession of the raw material inventory, the work in process inventory, the finished goods inventory and the shipping inventory to the manufacturing company, transfer the ownership of the raw material inventory, the work in process inventory and the finished goods inventory from the holding company to the manufacturing company, transfer the physical possession of the shipping inventory from the manufacturing company to the customer, and transfer the ownership of the shipping inventory from the manufacturing company to the customer. The system where the inventory possession model is configured to allocate the ownership of the raw material procurement, the raw material inventory, the work in process inventory, the finished goods inventory and the shipping inventory to the holding company allocate physical possession of the raw material inventory, the work in process inventory, the finished goods inventory and the shipping inventory to the manufacturing company transfer the physical possession of the shipping inventory from the manufacturing company to the customer, and transfer the ownership of the raw material inventory, the work in process inventory, the finished goods inventory and the shipping inventory from the holding company to the customer. The system where the inventory possession model is configured to allocate a risk amongst any of the holding company, the manufacturing company and the customer. The system where the risk may include any of shrinkage, scrap, obsolescence, rejection and material review board. The system where the work in process inventory may include any of a standard work product flow, a material review board work, a non-conforming work and a non-standard product flow. The system where the raw material inventory may include a plurality of raw materials. The system where the inventory possession model is configured to optimize a cash conversion cycle amongst any of the holding company, the manufacturing company and the customer. The system where the trigger point may include any of a point in a production and a point in a business cycle. The system where the date certain may include any of a calendar date, a contractual date, a delivery date and a scrap disposition date. Implementations of the described techniques may include hardware, a method or process, or a computer tangible medium.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of an inventory possession system of the prior art;

FIG. 2 is an illustration of an inventory possession system of the prior art;

FIG. 3 is an illustration of an inventory possession system in accordance with the present invention;

FIG. 4 is an illustration of an inventory possession system in accordance with the present invention;

FIG. 5 is an illustration of an inventory possession system in accordance with the present invention;

FIG. 6 is an illustration of an inventory possession system in accordance with the present invention;

FIG. 7 is an illustration of an inventory possession system in accordance with the present invention;

FIG. 8 is a flow chart of the a process of an inventory possession system in accordance with the present disclosure; and

FIG. 9 is a schematic block diagram illustrating a computing environment in accordance with the present disclosure.

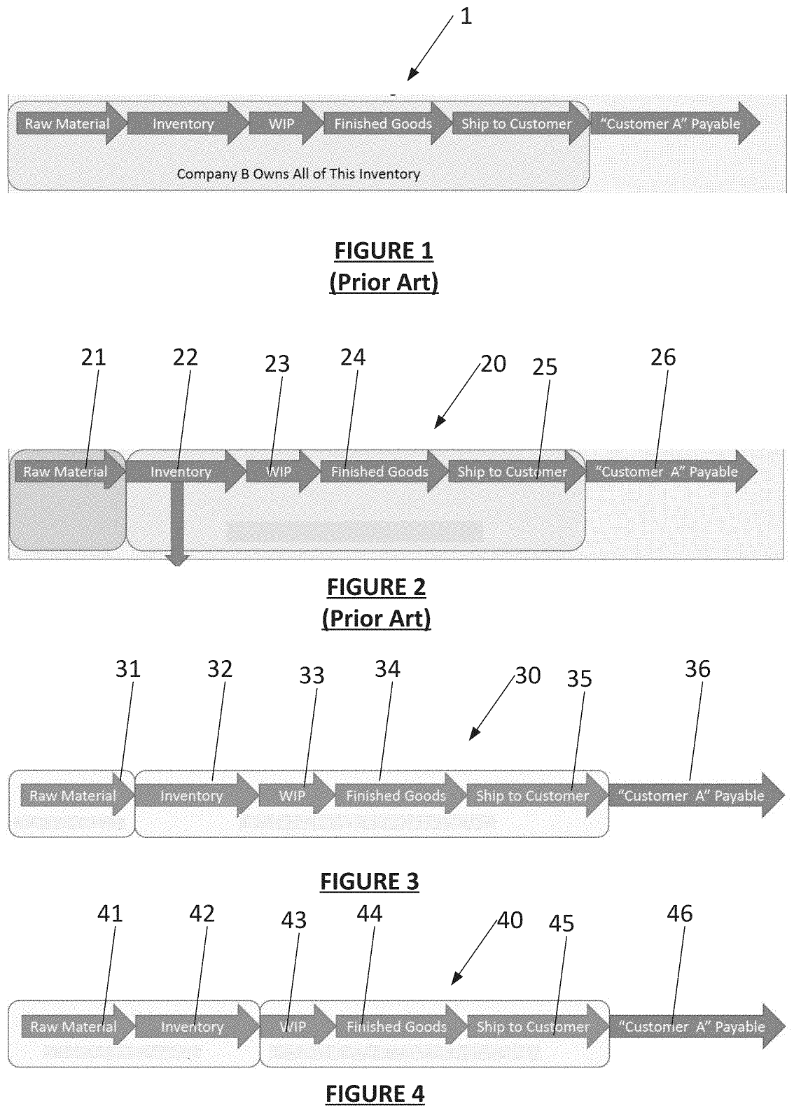

### DETAILED DESCRIPTION

In the following detailed description of the embodiments, reference is made to the accompanying drawings, which form a part hereof, and within which are shown by way of illustration specific embodiments by which the examples described herein may be practiced. It is to be understood that other embodiments may be utilized and structural changes may be made without departing from the scope of the disclosure.

Referring to FIG. 3, there is shown inventory possession model 30 (IPM) in accordance with the present disclosure. In this particular embodiment, Company B can be a manufacturing company preparing goods for sale to Customer A. Company C enters into a contractual arrangement with Company B and Company C purchases raw material. Company C can be referred to herein as a holding company wherein Company C “holds” a financial interest in the inventory up until a point of transfer to Company B as will be disclosed in more detail herein after. Company C owns the raw material, but Company B physically holds the raw material inventory at step 31. At a date certain or a trigger point, Company B transfers the ownership raw material to inventory at step 32 and pays Company C in accordance with predetermined financial terms, the detail of which will be covered herein after. Company B then owns and possesses the inventory from inventory of raw material at step 32, work in process (WIP) at step 33, to finished goods at step 34. Company B gives up physical possession of the finished goods, but still owns the finished goods, as they are shipped to Customer A at step 35. Customer A buys finished goods at step 36 or the “accounts payable step” in some cases, takes physical possession and ownership when Customer A pays Company B in accordance with their terms and the finished goods can go into Customer A inventory. In sum, in IPM 30 Company B has physical possession of the inventory at steps 31-35 and ownership at steps 32-35; Company C never has physical possession of the inventory but does have ownership at step 31; and Customer A takes ownership and possession of the inventory (in the form of finished goods) at step 36.

Referring next to FIG. 4, there is shown IPM 40 in accordance with the present disclosure. Company C enters into a contractual arrangement with Company B and Company C purchases raw material at step 41 and owns the raw material at purchase and inventory at step 42. Company B physically holds the raw material inventory beginning at step 41. At a date certain or a trigger point, Company B transfers the ownership of raw material at the beginning of WIP to inventory at step 43 and pays Company C in accordance with predetermined financial terms, the detail of which will be covered herein after. Company B then owns and possesses the inventory from WIP at step 43, to finished goods at step 44. Company B gives up physical possession of the finished goods, but still owns the finished goods, as they are shipped to Customer A at step 45. Customer A buys finished goods at step 46, takes physical possession and ownership when Customer A pays Company B in accordance with their terms and the finished goods can go into Customer A inventory. In sum, in IPM 40 Company B has physical possession of the inventory at steps 41-45 and ownership at steps 43-45; Company C never has physical possession of the inventory but does have ownership at steps 41-42; and Customer A takes ownership and possession of the inventory (in the form of finished goods) at step 46.

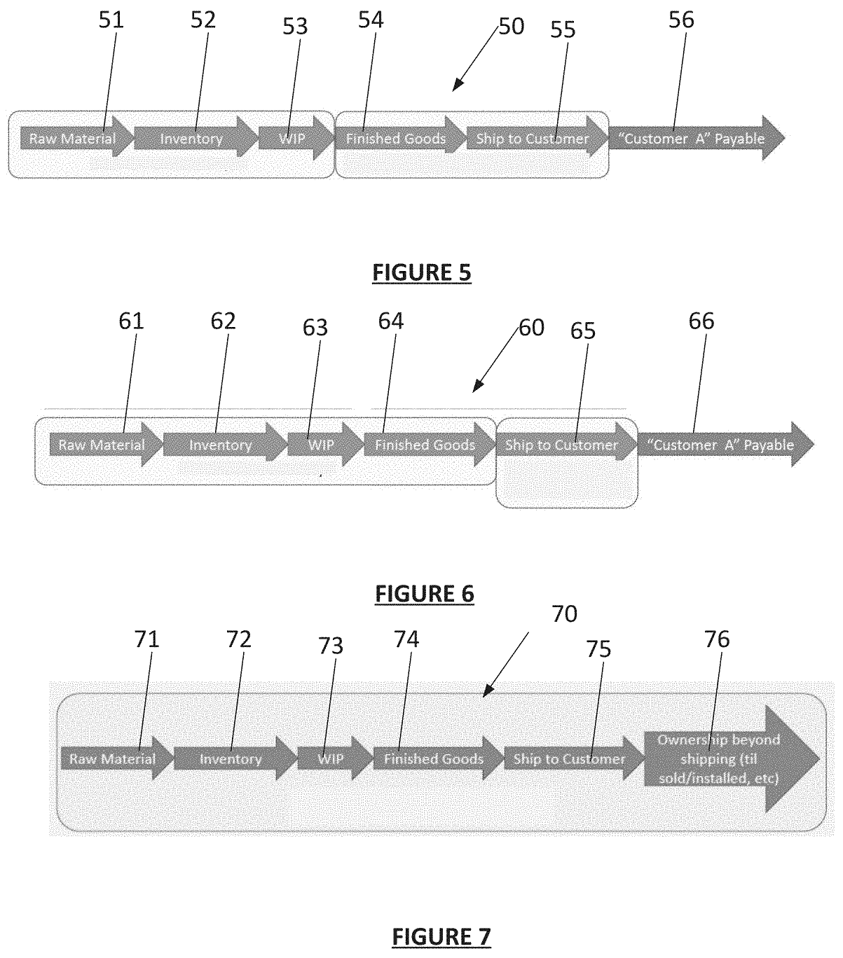

Referring now to FIG. 5, there is shown IPM 50 in accordance with the present disclosure. Company C enters into a contractual arrangement with Company B and Company C purchases raw material at step 51 and owns the raw material at purchase, inventory at step 52, and WIP at step 53. Company B physically holds the raw material inventory beginning at step 51. At a date certain or a trigger point, Company B transfers the ownership of raw material at the point where WIP is transformed into finished goods at step 54 and pays Company C in accordance with predetermined financial terms, the detail of which will be covered herein after. Company B then owns and possesses the inventory of finished goods at step 54. Company B gives up physical possession of the finished goods but may still own the finished goods as they are shipped to Customer A at step 55. In other embodiments Company B may not own goods at step 54 depending on contractual terms between the parties. In certain embodiments ownership of inventory can be transferred at the creation of shipping ticket, checking the parts into Customer A system, or other trigger point(s). Customer A buys finished goods at step 56, takes physical possession and ownership when Customer A pays Company B in accordance with their terms and the finished goods can go into Customer A inventory. In sum, in IPM 50 Company B has physical possession of the inventory at steps 51-55 and ownership at steps 54-55; Company C never has physical possession of the inventory but does have ownership at steps 51-53; and Customer A takes ownership and possession of the inventory (in the form of finished goods) at step 56.

Referring next to FIG. 6, there is shown IPM 60 in accordance with the present disclosure. Company C enters into a contractual arrangement with Company B and Company C purchases raw material at step 61 and owns the raw material at purchase, inventory at step 62, WIP at step 63 and the finished goods at step 64. Company B physically holds the raw material inventory beginning at step 61. At a date certain or a trigger point, Company B transfers the ownership of inventory of finished goods at step 64 and pays Company C in accordance with predetermined financial terms, the detail of which will be covered herein after. Company B then owns and possesses the inventory of finished goods at step 65 but Company B gives up physical possession of the finished goods when they are shipped to Customer A. Customer A buys finished goods at step 66, takes physical possession and ownership when Customer A pays Company B in accordance with their terms and the finished goods can go into Customer A inventory. In sum, in IPM 60 Company B has physical possession of the inventory at steps 61-65 and ownership at step 65; Company C never has physical possession of the inventory but does have ownership at steps 61-64; and Customer A takes ownership and possession of the inventory (in the form of finished goods) at step 66.

Referring next to FIG. 7, there is shown IPM 70 in accordance with the present disclosure wherein ownership and possession are kept completely separate throughout the inventory management cycle or business cycle. Company C enters into a contractual arrangement with Company B and Company C purchases raw material at step 71 and owns the raw material at purchase, inventory at step 72, WIP at step 73, finished goods at step 74 and through to shipping (or beyond) at step 76. Company B physically holds the raw material inventory beginning at step 71. Company B simply possesses the inventory of finished goods at step 75 but Company B gives up physical possession of the finished goods when they are shipped to Customer A. Customer A buys finished goods at step 76, takes physical possession and ownership when Customer A pays Company B in accordance with their terms and the finished goods can go into Customer A inventory. At about the same time in step 76 Company B pays company C for ownership of the inventory throughout the entire business cycle. In sum, in IPM 70 Company B has physical possession of the inventory at steps 71-75 and never has ownership; Company C never has physical possession of the inventory but does have ownership at steps 71-75; and Customer A takes ownership and possession of the inventory (in the form of finished goods) at step 76. It should be appreciated by those skilled in the art that in some business relationships, the supplier/manufacturer (Company B) is required to retain ownership even after the finished goods are delivered to the customer (Customer A), sometimes until the end use customer has possession of the finished goods and they are in use. It should be noted that although the term finished goods is used herein in the example embodiments, finished goods can be end use items or intermediate goods or assemblies destined for use in higher level assemblies and goods. In IPM 70, Company B, as a customer to Company C, can have raw material (or a plurality of raw materials), build parts, ship to next level customer (Customer A), wait to be paid in accordance with their terms, without ever owning, from a financial perspective, any of the inventory. In IPM 70 it is possible that Company B can sell simple or highly complex assemblies to Customer A on the same day that they buy the raw materials from Company C or Customer B can sell those goods/assemblies to Customer A before Customer B even buys the raw materials from Company C. It should be apparent to those skilled in the art that a cash conversion cycle, a metric that expresses the time (usually measured in days) it takes for a company to convert its investments in inventory and other resources into cash flows from sales can be optimized for Customer A in certain embodiments of the present disclosure and can be further optimized for a holding company or a manufacturing company.

It should be appreciated by those skilled in the art that as inventory progresses from raw materials, to WIP to finished goods, value is added to the inventory and the overall cost and value therefor increases. It should therefore be further appreciated that the various IPM's of the present disclosure include enormous flexibility for a manufacturer to free up capital along the manufacturing process and to effectively manage taxes and other costs (such as insurance) associated with physically holding inventory. It should also be appreciated by those skilled in the art that, depending on which IPM 30-70 is implemented, capital and tax advantages can be realized by each of the Companies A, B and C. The various IPM's disclosed herein can also allocate risk between the holding company and the manufacturer in terms of things like shrinkage, scrap, obsolescence, rejection and material review board items. As disclosed herein above, the ownership and possession roles can be established by trigger points such as point in the production or business cycle, upon demand, or at dates and events certain such as a calendar date, a contractual date, delivery date, scrap disposition date and the like.

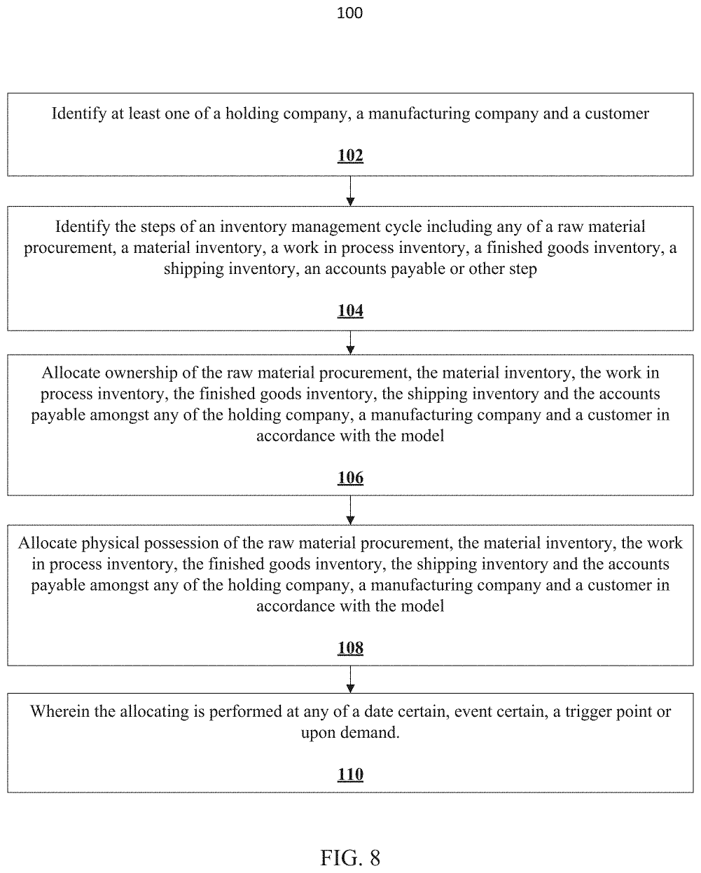

Now with reference to FIG. 8, there is shown a flow chart of a method 100 of performing an IPM in accordance with this disclosure. At step 102, Customer A, Company B and Company C are identified, as necessary. At step 104 the various steps of a manufacturing cycle are identified as necessary, such as those disclosed herein above with reference to the various FIGS. 2-7 such as raw material procurement, a material inventory, a work in process inventory, a finished goods inventory, a shipping inventory and an accounts payable. At step 106, the various IPMs 30-70 allocate the ownership at the various states of inventory amongst Customer A, Company B and Company C as appropriate. At step 108, the various IPMs 30-70 allocate the possession at the various states of inventory amongst Customer A, Company B and Company C. At step 110 the various triggering points are used with the selected IPM to allocate ownership and possession of the inventory during the manufacturing cycle.

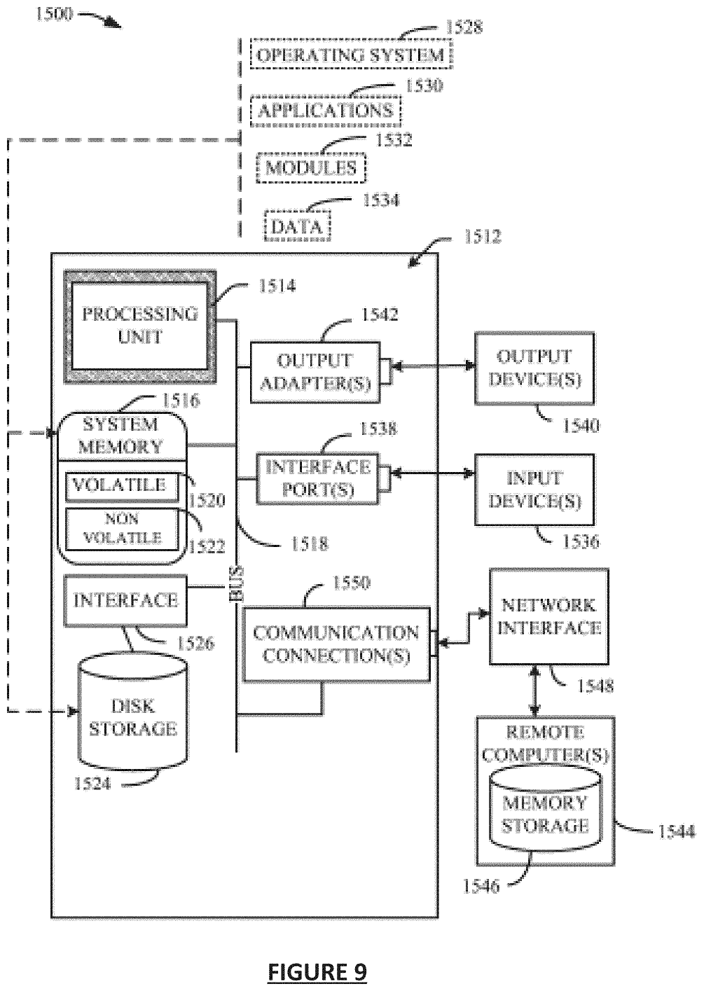

With reference to FIG. 9, a suitable environment 1500 for implementing various aspects of an inventory possession model of this disclosure includes a computer 1512. The computer 1512 includes computer executable components such as a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514.

The system bus 1518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1516 includes volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1520 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1512 also includes removable/non-removable, volatile/non-volatile computer storage media. FIG. 9 illustrates, for example, a disk storage 1524. Disk storage 1524 includes, but is not limited to, devices like a magnetic disk drive, floppy disk drive, tape drive, Jaz drive, Zip drive, LS-100 drive, flash memory card, or memory stick. The disk storage 1524 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1524 to the system bus 1518, a removable or non-removable interface is typically used, such as interface 1526.

FIG. 9 also depicts software that acts as an intermediary between users and the basic computer resources described in the suitable operating environment 1500. Such software includes, for example, an operating system 1528. Operating system 1528, which can be stored on disk storage 1524, acts to control and allocate resources of the computer system 1512. System applications 1530 take advantage of the management of resources by operating system 1528 through program modules 1532 and program data 1534, e.g., stored either in system memory 1516 or on disk storage 1524. It is to be appreciated that this disclosure can be implemented with various operating systems or combinations of operating systems.

A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port may be used to provide input to computer 1512, and to output information from computer 1512 to an output device 1540. Output adapter 1542 is provided to illustrate that there are some output devices 1540 like monitors, speakers, and printers, among other output devices 1540, which require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a personal computer, a server, a router, a network PC, a workstation, a microprocessor based appliance, a peer device or other common network node and the like, and typically includes many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1550 refers to the hardware/software employed to connect the network interface 1548 to the bus 1518. While communication connection 1550 is shown for illustrative clarity inside computer 1512, it can also be external to computer 1512. The hardware/software necessary for connection to the network interface 1548 includes, for exemplary purposes only, internal and external technologies such as, modems including regular telephone grade modems, cable modems and DSL modems, ISDN adapters, and Ethernet cards.

Various aspects or features described herein can be implemented as a method, apparatus, system, or article of manufacture using standard programming or engineering techniques. In addition, various aspects or features disclosed in this disclosure can be realized through program modules that implement at least one or more of IPMs and the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips), optical discs (e.g., compact disc (CD), digital versatile disc (DVD), Blu-ray disc (BD)), smart cards, and flash memory devices (e.g., card, stick, key drive), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

All of the methods disclosed and claimed herein can be made and executed without undue experimentation in light of the present disclosure. While the apparatus and methods of this disclosure have been described in terms of preferred embodiments, it will be apparent to those of skill in the art that variations may be applied to the methods and in the steps or in the sequence of steps of the method described herein without departing from the concept, spirit and scope of the disclosure. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the disclosure.

Although the invention(s) is/are described herein with reference to specific embodiments, various modifications and changes can be made without departing from the scope of the present invention(s), as presently set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated other The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

While the foregoing is directed to embodiments of the present disclosure, other and further embodiments of the disclosure may be devised without departing from the basic scope thereof, and the scope thereof is determined by the claims that follow.

What is claimed is:

1. An inventory possession method comprising:
identifying at least one of a holding company, a manufacturing company and a customer;
identifying the steps of an inventory management cycle including any of a raw material procurement, a raw material inventory, a work in process inventory, a finished goods inventory, a shipping inventory and an accounts payable; and
providing an inventory possession model comprising:
allocating ownership of the raw material procurement, the raw material inventory, the work in process inventory, the finished goods inventory, the shipping inventory and the accounts payable amongst any of the holding company, a manufacturing company and a customer; and
allocating physical possession of the raw material procurement, the raw material inventory, the work in process inventory, the finished goods inventory, the shipping inventory and the accounts payable amongst any of the holding company, a manufacturing company and a customer.

2. The inventory possession method of claim 1 wherein the allocating is performed at any of a date certain, an event certain, a trigger point or upon demand.

3. The inventory possession method of claim 2 comprising:
allocating the ownership of the raw material procurement to the holding company;
allocating physical possession of the raw material inventory, the work in process inventory, the finished goods inventory, the shipping inventory to the manufacturing company;
transferring the ownership of the raw material inventory from the holding company to the manufacturing company;
transferring the physical possession of the shipping inventory from the manufacturing company to the customer; and
transferring the ownership of the shipping inventory from the manufacturing company to the customer.

4. The inventory possession method of claim 2 comprising:
allocating the ownership of the raw material procurement and the raw material inventory to the holding company;
allocating physical possession of the raw material inventory, the work in process inventory, the finished goods inventory and the shipping inventory to the manufacturing company;
transferring the ownership of the raw material inventory from the holding company to the manufacturing company;
transferring the physical possession of the shipping inventory from the manufacturing company to the customer; and
transferring the ownership of the shipping inventory from the manufacturing company to the customer.

5. The inventory possession method of claim 2 comprising:
allocating the ownership of the raw material procurement, the raw material inventory and the work in process inventory to the holding company;
allocating physical possession of the raw material inventory, the work in process inventory, the finished goods inventory and the shipping inventory to the manufacturing company;
transferring the ownership of the raw material inventory and the work in process inventory from the holding company to the manufacturing company;
transferring the physical possession of the shipping inventory from the manufacturing company to the customer; and
transferring the ownership of the shipping inventory from the manufacturing company to the customer.

6. The inventory possession method of claim 2 comprising:
allocating the ownership of the raw material procurement, the raw material inventory, the work in process inventory and the finished goods inventory to the holding company;
allocating physical possession of the raw material inventory, the work in process inventory, the finished goods inventory and the shipping inventory to the manufacturing company;
transferring the ownership of the raw material inventory, the work in process inventory and the finished goods inventory from the holding company to the manufacturing company;
transferring the physical possession of the shipping inventory from the manufacturing company to the customer; and
transferring the ownership of the shipping inventory from the manufacturing company to the customer.

7. The inventory possession method of claim 2 comprising:
allocating the ownership of the raw material procurement, the raw material inventory, the work in process inventory, the finished goods inventory and the shipping inventory to the holding company;
allocating physical possession of the raw material inventory, the work in process inventory, the finished goods inventory and the shipping inventory to the manufacturing company;
transferring the physical possession of the shipping inventory from the manufacturing company to the customer; and
transferring the ownership of the raw material inventory, the work in process inventory, the finished goods inventory and the shipping inventory from the holding company to the customer.

8. An inventory possession system comprising:
a microprocessor configured to:
identify at least one of each of a holding company, a manufacturing company and a customer;
identify the steps of an inventory management cycle including any of a raw material procurement, a material inventory, a work in process inventory, a finished goods inventory, a shipping inventory and an accounts payable;
allocate ownership of the raw material procurement, the material inventory, the work in process inventory, the finished goods inventory, the shipping inventory and the accounts payable amongst each of the holding company, a manufacturing company and a customer in accordance with an inventory possession model;
allocate physical possession of the raw material procurement, the material inventory, the work in process inventory, the finished goods inventory, the shipping inventory and the accounts payable amongst each of the holding company, a manufacturing company and a customer in accordance with the inventory possession model; and
wherein the allocating is performed at any of a date certain, a trigger point or upon demand.

9. A system comprising:
one or more processors configured to:
identify at least one of a holding company, a manufacturing company and a customer;
identify the steps of an inventory management cycle including any of a raw material procurement, a raw material inventory, a work in process inventory, a finished goods inventory, a shipping inventory and an accounts payable; and
provide an inventory possession model configured to:
allocate ownership of the raw material procurement, the raw material inventory, the work in process inventory, the finished goods inventory, the shipping inventory and the accounts payable amongst any of the holding company, a manufacturing company and a customer; and
allocate physical possession of the raw material procurement, the raw material inventory, the work in process inventory, the finished goods inventory, the shipping inventory and the accounts payable amongst any of the holding company, a manufacturing company and a customer.

10. The system of claim 9, wherein the inventory possession model is further configured to allocate the ownership and allocate physical possession at any of a date certain, an event certain, a trigger point or upon demand.

11. The system of claim 10, wherein the inventory possession model is configured to:
allocate the ownership of the raw material procurement to the holding company;
allocate physical possession of the raw material inventory, the work in process inventory, the finished goods inventory, the shipping inventory to the manufacturing company;
transfer the ownership of the raw material inventory from the holding company to the manufacturing company;
transfer the physical possession of the shipping inventory from the manufacturing company to the customer; and
transfer the ownership of the shipping inventory from the manufacturing company to the customer.

12. The system of claim 10, wherein the inventory possession model is configured to:
allocate the ownership of the raw material procurement and the raw material inventory to the holding company;
allocate physical possession of the raw material inventory, the work in process inventory, the finished goods inventory and the shipping inventory to the manufacturing company;
transfer the ownership of the raw material inventory from the holding company to the manufacturing company;
transfer the physical possession of the shipping inventory from the manufacturing company to the customer; and
transfer the ownership of the shipping inventory from the manufacturing company to the customer.

13. The system of claim 10, wherein the inventory possession model is configured to:
allocate the ownership of the raw material procurement, the raw material inventory and the work in process inventory to the holding company;
allocate physical possession of the raw material inventory, the work in process inventory, the finished goods inventory and the shipping inventory to the manufacturing company;
transfer the ownership of the raw material inventory and the work in process inventory from the holding company to the manufacturing company;
transfer the physical possession of the shipping inventory from the manufacturing company to the customer; and
transfer the ownership of the shipping inventory from the manufacturing company to the customer.

14. The system of claim 10, wherein the inventory possession model is configured to:
allocate the ownership of the raw material procurement, the raw material inventory, the work in process inventory and the finished goods inventory to the holding company;
allocate physical possession of the raw material inventory, the work in process inventory, the finished goods inventory and the shipping inventory to the manufacturing company;
transfer the ownership of the raw material inventory, the work in process inventory and the finished goods inventory from the holding company to the manufacturing company;
transfer the physical possession of the shipping inventory from the manufacturing company to the customer; and
transfer the ownership of the shipping inventory from the manufacturing company to the customer.

15. The system of claim 10, wherein the inventory possession model is configured to:
allocate the ownership of the raw material procurement, the raw material inventory, the work in process inventory, the finished goods inventory and the shipping inventory to the holding company
allocate physical possession of the raw material inventory, the work in process inventory, the finished goods inventory and the shipping inventory to the manufacturing company
transfer the physical possession of the shipping inventory from the manufacturing company to the customer; and
transfer the ownership of the raw material inventory, the work in process inventory, the finished goods inventory and the shipping inventory from the holding company to the customer.

16. The system of claim 10, wherein the inventory possession model is configured to allocate a risk amongst any of the holding company, the manufacturing company and the customer.

17. The system of claim 16, wherein the risk comprises any of shrinkage, scrap, obsolescence, rejection and material review board.

18. The system of claim 10, wherein the work in process inventory comprises any of a standard work product flow, a material review board work, a non-conforming work and a non-standard product flow.

19. The system of claim 10, wherein the raw material inventory comprises a plurality of raw materials.

20. The system of claim 10, wherein the inventory possession model is configured to optimize a cash conversion cycle amongst any of the holding company, the manufacturing company and the customer.

21. The system of claim 10, wherein the trigger point comprises any of a point in a production and a point in a business cycle.

22. The system of claim 10, wherein the date certain comprises any of a calendar date, a contractual date, a delivery date and a scrap disposition date.
